(19) United States
(12) Patent Application Publication
(10) Pub. No.: US 2010/0255604 A1
(43) Pub. Date: Oct. 7, 2010

(54) Sample introduction solutions and methods

(76) Inventor: Nathan Saetveit, Omaha, NE (US)

Correspondence Address: SUITER SWANTZ PC LLO, 14301 FNB PARKWAY, SUITE 220, OMAHA, NE, 68154, US

(21) Appl. No.: 12/384,566

(22) Filed: Apr. 7, 2009

(51) Int. Cl. G01N 1/28; G01N 31/22

(52) U.S. Cl. 436/174; 252/408.1

(57) ABSTRACT

A sample introduction solution includes nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 8 percent by volume.

### FIELD

The present application generally relates to the field of chemical analysis, and more particularly to a sample introduction solution and methods for introducing a sample to analytical equipment.

### BACKGROUND

Analytical equipment, including mass spectrometers (MS) and atomic emission spectrometers (AES), are utilized for detecting trace elements of species in samples. Inductively Coupled Plasma MS (ICP-MS) and Inductively Coupled Plasma AES (ICP-AES) are two common analytical tools used by laboratories for the determination of trace element concentrations in liquid samples. The ICP is an electromagnetically generated partially ionized argon plasma with a temperature of approximately 7000K. When a sample is introduced to the ICP, the high temperature causes sample atoms to become ionized or emit light. Since each chemical element produces a characteristic mass or emission spectrum, measuring the spectra allows the determination of the elemental composition of the original sample. Such sample analysis systems may employ a sample introduction system for conditioning a sample prior to introduction into the analytical equipment. A sample may be introduced to the analytical equipment by the sample introduction system, whereby a concentration of elements and a ratio of isotopes may be detected by the analytical equipment.

### SUMMARY

A sample introduction solution for increasing the sensitivity of a sample to detection of trace elements by analytical equipment includes nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 8 percent by volume.

A method of increasing analysis sensitivity of a sample includes preparing an initial sample solution using at least one of nitric acid or hydrochloric acid, determining whether the initial sample solution includes a sufficient amount of hydrochloric acid to obtain a hydrochloric acid concentration of between 0.1 percent and 4 percent by volume in a mixed sample solution, and adding a sufficient amount of at least one of sulfuric acid, hydrogen peroxide, or hydrochloric acid according to the determination to provide in the mixed sample solution a sulfuric acid concentration of between approximately 0.1 percent and 4 percent by volume, a hydrogen peroxide concentration of between approximately 0.1 percent and 9 percent by volume, a hydrochloric acid concentration of between approximately 0.1 percent and 4 percent by volume, and a nitric acid concentration of between approximately 1 percent and 10 percent by volume.

A method of introducing a sample for analysis includes introducing a sample to a sample introduction system, the sample including nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 4 percent by volume, heating the sample, and introducing the sample to an analytic system.

It is to be understood that both the foregoing general description and the following detailed description are exemplary and explanatory only and are not necessarily restrictive as claimed. The accompanying drawings, which are incorporated in and constitute a part of the specification, illustrate an embodiment and together with the general description, serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram of a sample analysis including a sample introduction system;

FIG. 2A is a block diagram of an embodiment of a sample introduction solution;

FIG. 2B is a block diagram of an embodiment of a mixed sample solution;

FIG. 3 illustrates an operational flow representing example operations related to increasing analysis sensitivity of a sample;

FIG. 4 illustrates an alternative embodiment of the operational flow of FIG. 3;

FIG. 5 illustrates an alternative embodiment of the operational flow of FIG. 3;

FIG. 6 illustrates an alternative embodiment of the operational flow of FIG. 3;

FIG. 7 illustrates an alternative embodiment of the operational flow of FIG. 3;

FIG. 8 illustrates an alternative embodiment of the operational flow of FIG. 3;

FIG. 9 illustrates an alternative embodiment of the operational flow of FIG. 3;

FIG. 10 illustrates an alternative embodiment of the operational flow of FIG. 3;

FIG. 11 is a graph of intensity over time of a sample analyzed on analytic equipment, the sample being heated for a period;

FIG. 12 illustrates an operational flow representing example operations related to introducing a sample for analysis;

FIG. 13 illustrates an alternative embodiment of the operational flow of FIG. 12; and

FIG. 14 illustrates an alternative embodiment of the operational flow of FIG. 12.

### DETAILED DESCRIPTION

Reference will now be made in detail to the presently preferred embodiments of the disclosure, examples of which are illustrated in the accompanying drawings.

Referring now to FIG. 1, a sample introduction solution 102 of the present disclosure may be utilized to provide enhanced sensitivity of a sample to detection of trace elements by analytical equipment 108. The sample introduction solution 102 may be introduced to a sample introduction system 106 for conditioning a sample prior to introduction into analytical equipment 108. Analytical equipment 108 suitable for analyzing a sample 104 conditioned with the sample introduction solution 102 may include mass spectrometers (MS), including inductively couple plasma mass spectrometers (ICP-MS), atomic emission spectrometers (AES), including inductively coupled plasma atomic emission spectrometers (ICP-AES), optical emission spectrometers, including inductively coupled plasma optical emission spectrometers (ICP-OES), and other instrumentation or equipment suitable for analyzing a sample including trace elements. For instance, a sample introduction solution 102 including a sample solution 104 and concentrations of nitric acid (HNO₃), hydrochloric acid (HCl), sulfuric acid (H₂SO₄), and hydrogen peroxide (H₂O₂) may be introduced to the sample introduction system 106. After conditioning in the sample introduction system 106, the sample introduction solution 102 and the sample solution 104 (which may collectively be referred to as a mixed sample solution 107) may be introduced to the analytical equipment 108 for testing.

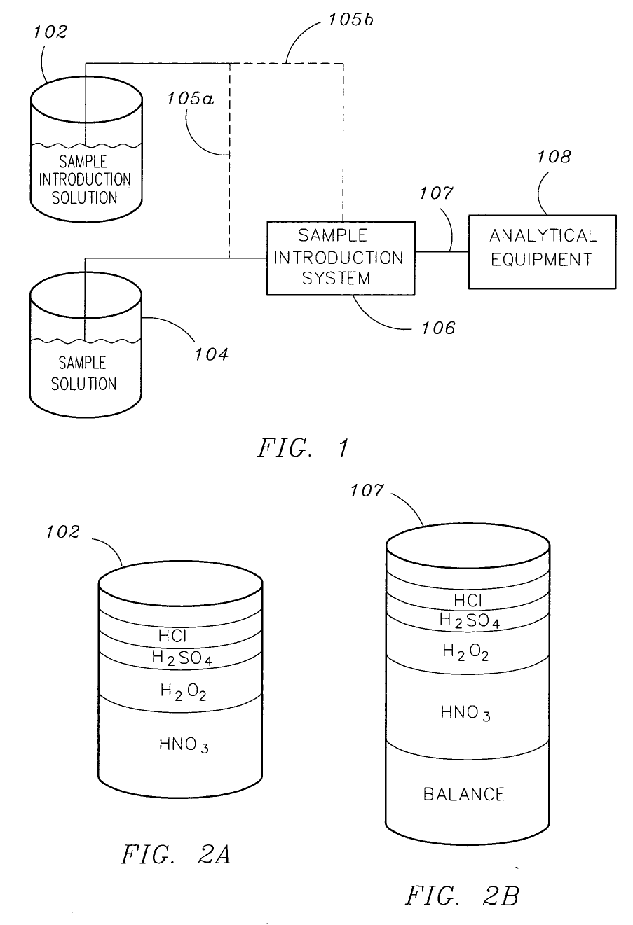

In one embodiment, the sample introduction solution 102 and the sample solution are combined 105a prior to introduction in the sample introduction system 106. In an alternative embodiment, the sample introduction solution 102 and the sample solution are combined 105b after to introduction in the sample introduction system 106, such as by using separate introduction points, or by introducing the solutions to the sample introduction system 106 at different times. In another alternative embodiment, at least a portion of the sample introduction solution 102 and the sample solution 104 may be combined 105a prior to introduction in the sample introduction system 106, whereas at least a portion of the sample introduction solution 102 and the sample solution 104 may be combined 105b after to introduction in the sample introduction system 106. For instance, referring to FIG. 2A, the sample introduction solution 102 may include a combination of hydrochloric acid, sulfuric acid, hydrogen peroxide, and nitric acid, wherein a mixture of the chemicals may be separated for introduction prior to 105a and after 105b introduction in the sample introduction system 106, or the individual chemicals may be separated such that one or more chemicals combine with the sample solution 104 prior to 105a introduction in the sample introduction system 106 and the balance of the chemicals of the sample introduction solution 102 are combined after 105b introduction in the sample introduction system 106. For example, nitric acid may be combined with the sample solution 104 prior to 105a introduction in the sample introduction system 106, and hydrochloric acid, sulfuric acid, and hydrogen peroxide are combined after 105b introduction in the sample introduction system 106. However, it is appreciated that any combination of the chemicals of the sample introduction solution 102 may be combined with the sample solution 104 prior to 105b and/or after 105b introduction to the sample introduction system 106. Additionally, it may be appreciated that various chemicals of the sample introduction solution 102 may be introduced to the sample introduction system 106 at separate introduction times.

The sample introduction system 106 may be a system that is suitable for conditioning a sample prior to introduction into analytical equipment 108. For example, the sample introduction system 106 may provide heating and cooling elements, pumps for providing pressure to a fluid line, flow rate controls, fluid lines or chambers for providing a residence time (such as for allowing chemicals to react or fluids to separate), carrier fluids for transporting samples, injection ports for allowing chemicals, samples, and the like to be introduced at various points in the fluid line, and other instrumentality and functionality suitable for conditioning a sample prior to introduction into analytical equipment 108. The sample which is introduced to the analytical equipment 108 may be the mixed sample solution 107, an embodiment of which is displayed in FIG. 2B. The mixed sample solution 107 may include hydrochloric acid, sulfuric acid, hydrogen peroxide, nitric acid, and a balance, which may include a sample and solutions used to prepare the sample and to dilute the other chemicals, such as aqueous solutions. While FIGS. 2A and 2B display the chemicals as layered, it may be appreciated that the chemicals may be mixed in solution, or that the layers may indicate that the chemicals are not physically mixed as a single solution, but rather the sample introduction solution may be a kit of separate chemicals to be combined at various stages of sample preparation, as described before.

Conditioning by the sample introduction system may permit various physical and chemical processes to occur prior to introduction of the mixed sample solution 107 to the analytical equipment 108. For instance, such physical and chemical processes may include heating, cooling, chemical reactions (including oxidation/reduction reactions), pressurizing, vaporizing, condensing, nebulizing, and other processes known in the art.

In an embodiment, a sample introduction solution 102 includes nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 8 percent by volume. When the sample introduction solution 102 is combined with the sample solution 104, the balance of the mixed sample solution 107 may include a sample to be tested which may include a solvent, a carrier fluid, or the like. For instance, a sample may include trace elements which may be tested for in environmental analyses. Such trace elements may include arsenic (As), including reduced forms such as As³⁺, selenium (Se), including reduced forms such as Se⁴⁺, Thallium (TI), Lead (Pb), and other elements of environmental, physiological, and/or pharmacological concern. However, analytic equipment 108 may respond differently to different oxidation/reduction states, such as by having increased sensitivity to one state of an element as compared to a different state. For example, analytic equipment 108 that has increased sensitivity in measuring a particular state of an element may provide increased intensity in detecting the presence of and measuring the concentration of the element.

When mixed with a sample, the sample introduction solution 102 of the embodiment discussed above may facilitate the conversion of reduced species of elements including arsenic and selenium into oxidized species. The oxidized species, including As⁵⁺ and Se⁶⁺, may provide greater sensitivity when tested by analytical equipment 108. The chemical addition of the sample introduction solution 102 with the sample solution 104 may convert reduced species to oxidized forms prior to analysis, which may provide enhanced sensitivity and consistent testing results across samples containing As and Se in different oxidation states.

In the embodiment of the sample introduction solution 102 provided above, the amount of nitric acid may be between approximately 2 percent and 5 percent by volume. Additionally, the amount of hydrochloric acid may be between approximately 0.2 percent and 2 percent by volume. Further, the amount of sulfuric acid may be between approximately 0.2 and 2 percent by volume. Still further, the amount of hydrogen peroxide may be between approximately 0.5 percent and 1.5 percent. In another embodiment, a sample introduction solution includes nitric acid in an amount approximately 4 percent by volume, hydrochloric acid in an amount approximately 0.5 percent by volume, sulfuric acid in an amount approximately 0.5 percent by volume, and hydrogen peroxide in an amount approximately 1 percent by volume.

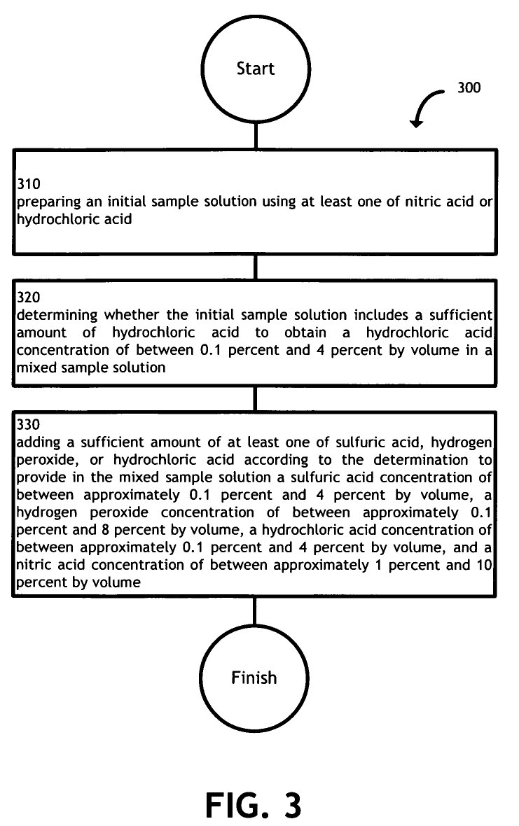

FIG. 3 illustrates an operational flow 300 representing example operations related to increasing analysis sensitivity of a sample. In FIG. 3 and in following figures that include various examples of operational flows, discussion and explanation may be provided with respect to the above-described examples of FIGS. 1 through 2A and 2B, and/or with respect to other examples and contexts. However, it should be understood that the operational flows may be executed in a number of other environments and contexts, and/or in modified versions of FIGS. 1 through 2A and 2B. Also, although the various operational flows are presented in the sequence(s) illustrated, it should be understood that the various operations may be performed in other orders than those which are illustrated, or may be performed concurrently.

After a start operation, the operational flow 300 moves to an operation 310. Operation 310 depicts preparing an initial sample solution using at least one of nitric acid or hydrochloric acid. For example, as shown in FIGS. 1 through 2A and 2B, the initial sample solution may include combining the sample solution 104 with at least one of nitric acid or hydrochloric acid prior to 105a introduction to the sample introduction system. Then, operation 320 depicts determining whether the initial sample solution includes a sufficient amount of hydrochloric acid to obtain a hydrochloric acid concentration of between 0.1 percent and 4 percent by volume in a mixed sample solution. For example, as shown in FIGS. 1 through 2A and 2B, depending on the preparation of sample solution 104, a determination may be made to determine whether the mixed sample solution 107 will include a hydrochloric acid concentration of between 0.1 percent and 4 percent by volume.

Then, operation 330 depicts adding a sufficient amount of at least one of sulfuric acid, hydrogen peroxide, or hydrochloric acid according to the determination to provide in the mixed sample solution a sulfuric acid concentration of between approximately 0.1 percent and 4 percent by volume, a hydrogen peroxide concentration of between approximately 0.1 percent and 8 percent by volume, a hydrochloric acid concentration of between approximately 0.1 percent and 4 percent by volume, and a nitric acid concentration of between approximately 1 percent and 10 percent by volume. For example, as shown in FIGS. 1 through 2A and 2B, at least one of hydrochloric acid, sulfuric acid, hydrogen peroxide, or nitric acid may be added prior to 105a and/or after 105b introduction to the sample introduction system 106.

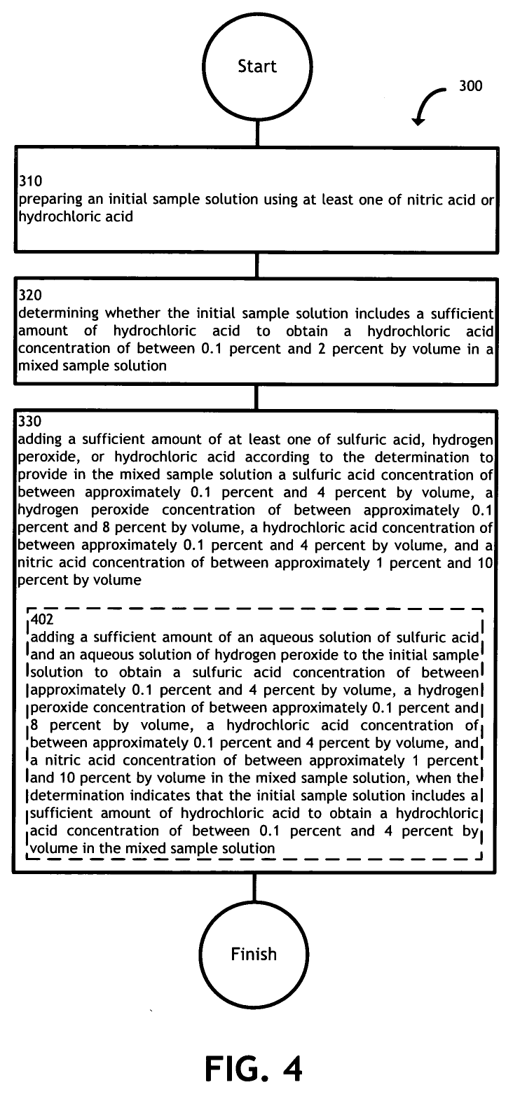

FIG. 4 illustrates alternative embodiments of the example operational flow 300 of FIG. 3. FIG. 4 illustrates example embodiments where the operation 330 may include at least one additional operation. Additional operations may include an operation 402. The operation 402 illustrates adding a sufficient amount of an aqueous solution of sulfuric acid and an aqueous solution of hydrogen peroxide to the initial sample solution to obtain a sulfuric acid concentration of between approximately 0.1 percent and 4 percent by volume, a hydrogen peroxide concentration of between approximately 0.1 percent and 8 percent by volume, a hydrochloric acid concentration of between approximately 0.1 percent and 4 percent by volume, and a nitric acid concentration of between approximately 1 percent and 10 percent by volume in the mixed sample solution, when the determination indicates that the initial sample solution includes a sufficient amount of hydrochloric acid to obtain a hydrochloric acid concentration of between 0.1 percent and 4 percent by volume in the mixed sample solution. For example, as shown in FIGS. 1 through 2A and 2B, a determination may be made to determine whether the sample solution 104 contains a sufficient amount of hydrochloric acid to obtain a hydrochloric acid concentration of between 0.1 percent and 4 percent by volume in the mixed sample solution 107. If the determination indicates that the sample solution 104 contains a sufficient amount of hydrochloric acid to obtain a hydrochloric acid concentration of between 0.1 percent and 4 percent by volume in the mixed sample solution 107, a sufficient amount of an aqueous solution of sulfuric acid and an aqueous solution of hydrogen peroxide may be added to the initial sample solution to obtain a sulfuric acid concentration of between approximately 0.1 percent and 4 percent by volume, a hydrogen peroxide concentration of between approximately 0.1 percent and 8 percent by volume, a hydrochloric acid concentration of between approximately 0.1 percent and 4 percent by volume, and a nitric acid concentration of between approximately 1 percent and 10 percent by volume in the mixed sample solution 107.

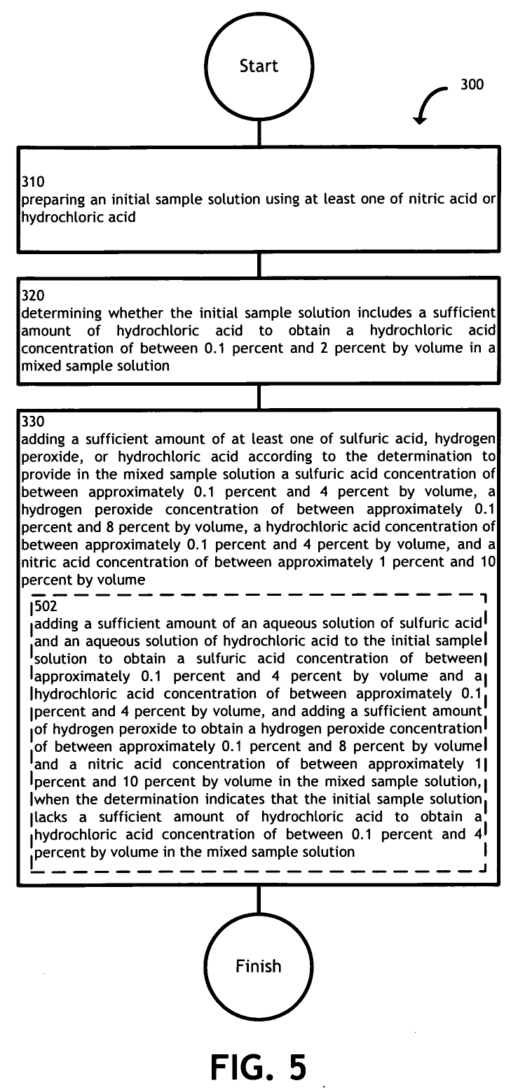

FIG. 5 illustrates alternative embodiments of the example operational flow 300 of FIG. 3. FIG. 5 illustrates example embodiments where the operation 330 may include at least one additional operation. Additional operations may include an operation 502. The operation 502 illustrates adding a sufficient amount of an aqueous solution of sulfuric acid and an aqueous solution of hydrochloric acid to the initial sample solution to obtain a sulfuric acid concentration of between approximately 0.1 percent and 4 percent by volume and a hydrochloric acid concentration of between approximately 0.1 percent and 4 percent by volume, and adding a sufficient amount of hydrogen peroxide to obtain a hydrogen peroxide concentration of between approximately 0.1 percent and 8 percent by volume and a nitric acid concentration of between approximately 1 percent and 10 percent by volume in the mixed sample solution, when the determination indicates that the initial sample solution lacks a sufficient amount of hydrochloric acid to obtain a hydrochloric acid concentration of between 0.1 percent and 4 percent by volume in the mixed sample solution. For example, as shown in FIGS. 1 through 2A and 2B, a determination may be made to determine whether the sample solution 104 contains a sufficient amount of hydrochloric acid to obtain a hydrochloric acid concentration of between 0.1 percent and 4 percent by volume in the mixed sample solution 107. If the determination indicates that the sample solution 104 does not contain a sufficient amount of hydrochloric acid to obtain a hydrochloric acid concentration of between 0.1 percent and 4 percent by volume in the mixed sample solution 107, a sufficient amount of an aqueous solution of sulfuric acid and an aqueous solution of hydrochloric acid may be added to the initial sample solution to obtain a sulfuric acid concentration of between approximately 0.1 percent and 4 percent by volume and a hydrochloric acid concentration of between approximately 0.1 percent and 4 percent by volume in the mixed sample solution 107. Additionally, a sufficient amount of hydrogen peroxide may be added to obtain a hydrogen peroxide concentration of between approximately 0.1 percent and 8 percent by volume and a nitric acid concentration of between approximately 1 percent and 10 percent by volume in the mixed sample solution 107.

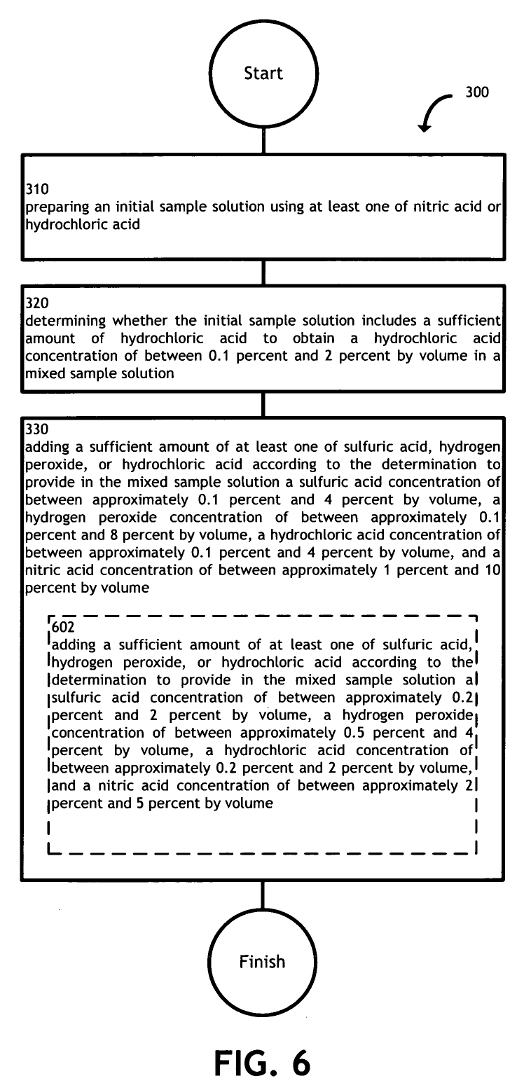

FIG. 6 illustrates alternative embodiments of the example operational flow 300 of FIG. 3. FIG. 6 illustrates example embodiments where the operation 330 may include at least one additional operation. Additional operations may include an operation 602. The operation 602 illustrates adding a sufficient amount of at least one of sulfuric acid, hydrogen peroxide, or hydrochloric acid according to the determination to provide in the mixed sample solution a sulfuric acid concentration of between approximately 0.2 percent and 2 percent by volume, a hydrogen peroxide concentration of between approximately 0.5 percent and 4 percent by volume, a hydrochloric acid concentration of between approximately 0.2 percent and 2 percent by volume, and a nitric acid concentration of between approximately 2 percent and 5 percent by volume.

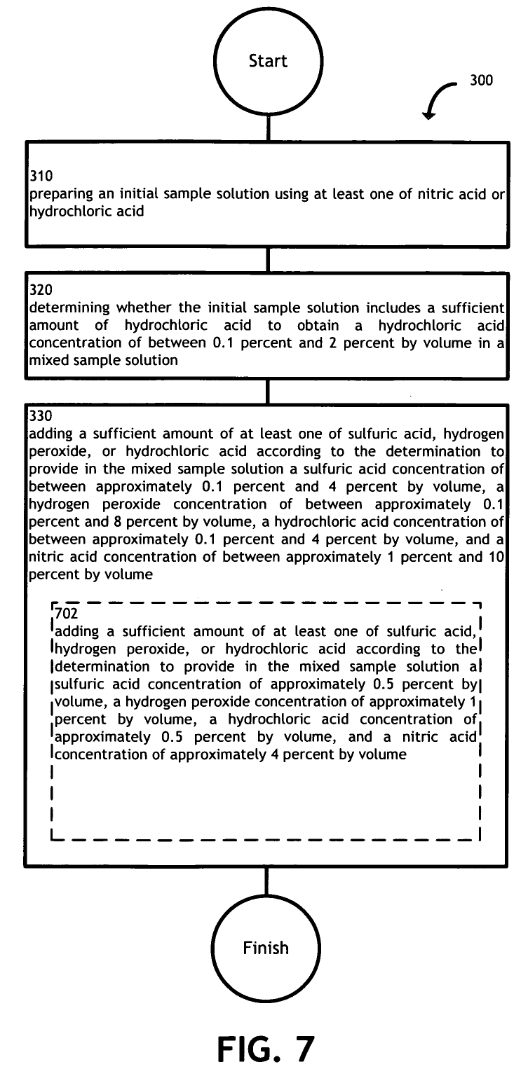

FIG. 7 illustrates alternative embodiments of the example operational flow 300 of FIG. 3. FIG. 7 illustrates example embodiments where the operation 330 may include at least one additional operation. Additional operations may include an operation 702. The operation 702 illustrates adding a sufficient amount of at least one of sulfuric acid, hydrogen peroxide, or hydrochloric acid according to the determination to provide in the mixed sample solution a sulfuric acid concentration of approximately 0.5 percent by volume, a hydrogen peroxide concentration of approximately 1 percent by volume, a hydrochloric acid concentration of approximately 0.5 percent by volume, and a nitric acid concentration of approximately 4 percent by volume.

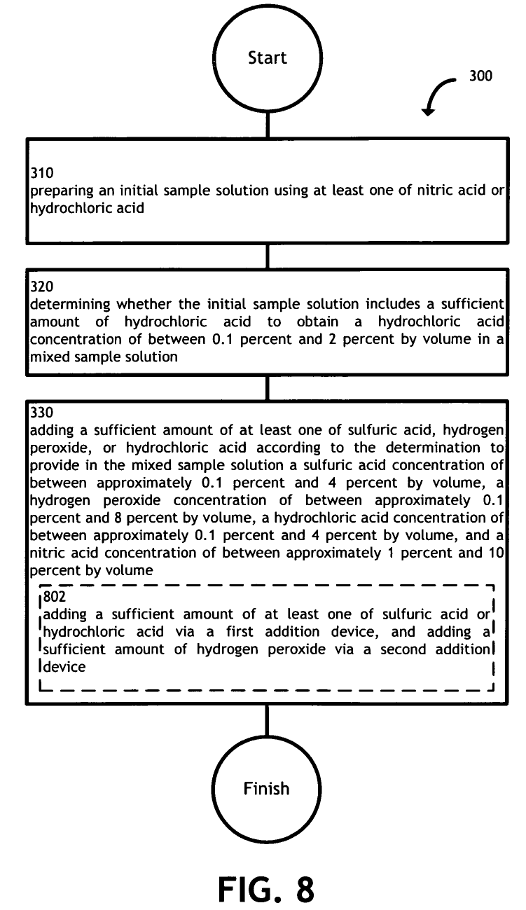

FIG. 8 illustrates alternative embodiments of the example operational flow 300 of FIG. 3. FIG. 8 illustrates example embodiments where the operation 330 may include at least one additional operation. Additional operations may include an operation 802. The operation 802 illustrates adding a sufficient amount of at least one of sulfuric acid or hydrochloric acid via a first addition device, and adding a sufficient amount of hydrogen peroxide via a second addition device. For example, the first addition device may be a first internal standard tee, and the second addition device may be a second internal standard tee. The first internal standard tee and the second internal standard tee may be utilized to introduce at least a portion of a solution into a solution introduction system, such as into a carrier fluid in the solution introduction system. Separating the addition of at least one of sulfuric acid and hydrochloric acid from the addition of hydrogen peroxide may prevent substantial decomposition of the hydrogen peroxide in an acidic presence before the hydrogen peroxide may aid in the oxidation of elements to be analyzed. Thus, it may be appreciated that the hydrogen peroxide of the mixed sample solution maintains a separate state from an acidic environment before introduction to the sample solution, and mixed with acid (e.g., hydrochloric acid, sulfuric acid, and/or nitric acid) just prior to analyzing the mixed sample solution with analytical equipment.

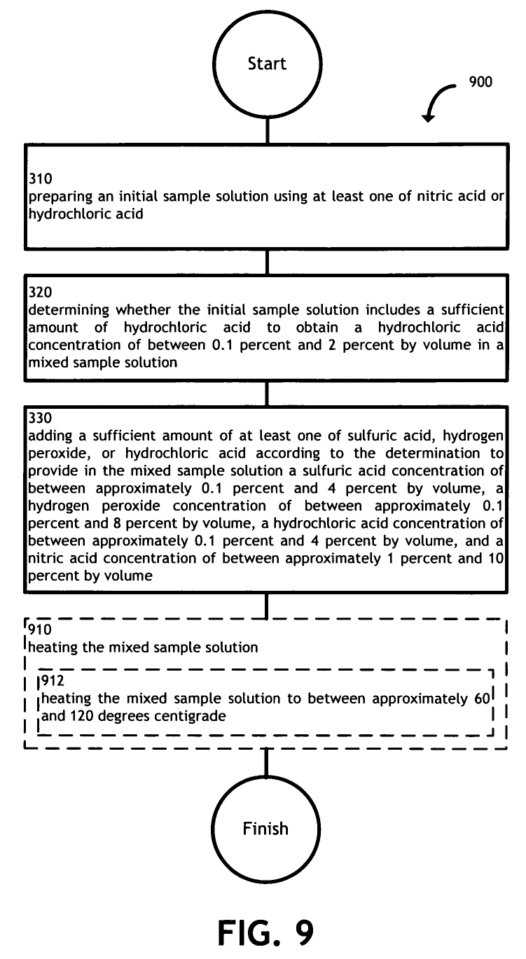

FIG. 9 illustrates an operational flow 900 representing example operations related to increasing analysis sensitivity of a sample. FIG. 9 illustrates an example embodiment where the example operational flow 300 of FIG. 3 may include at least one additional operation. Additional operations may include an operation 910, and/or an operation 912. After a start operation, an operation 310, an operation 320, and an operation 330, the operational flow 900 moves to an operation 910. Operation 910 illustrates heating the mixed sample solution. For example, as shown in FIGS. 1 through 2, the mixed sample solution 107 may be heated by the sample introduction system 106, which is discussed further below. The operation 912 illustrates heating the mixed sample solution to between approximately 60 and 120 degrees centigrade.

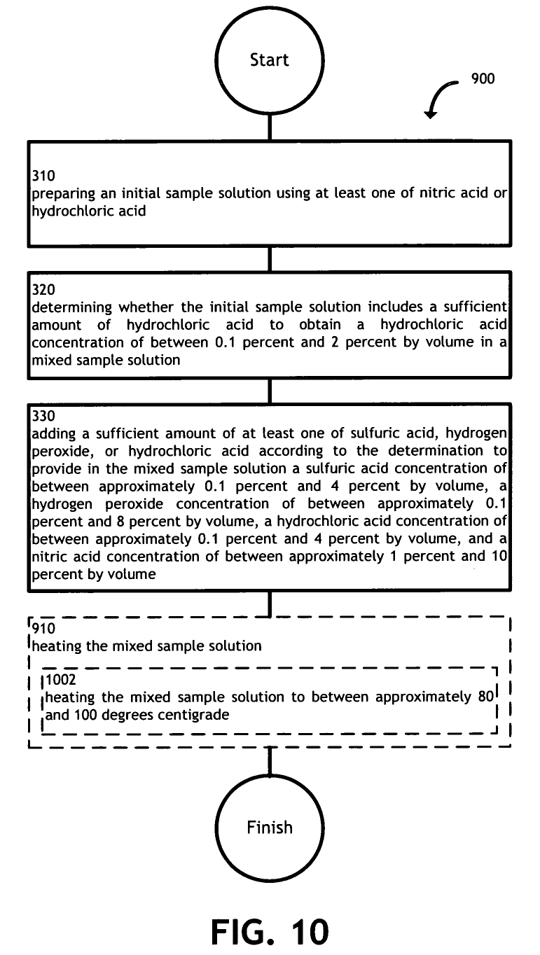

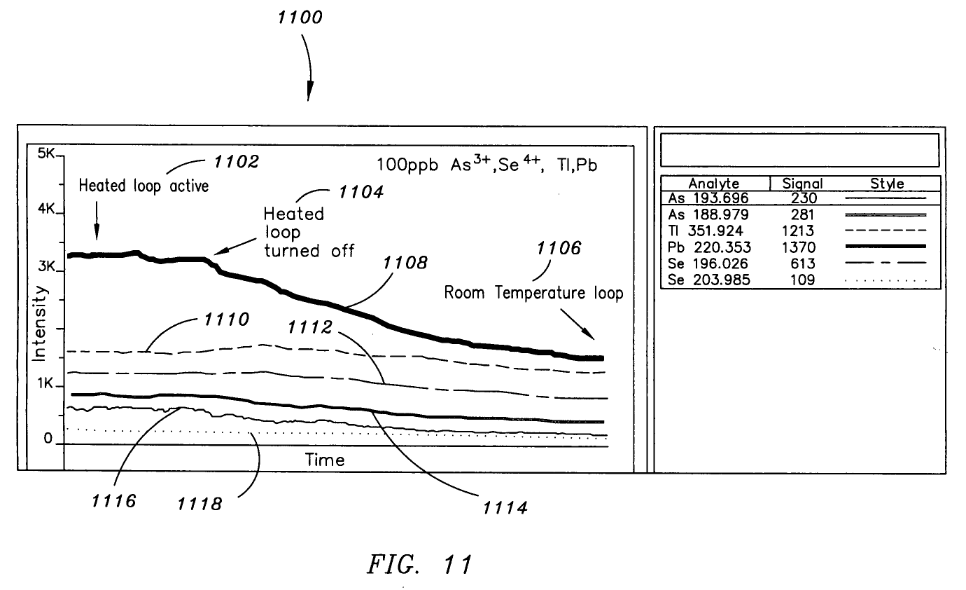

FIG. 10 illustrates alternative embodiments of the example operational flow 900 of FIG. 9. FIG. 10 illustrates example embodiments where the operation 910 may include at least one additional operation. Additional operations may include an operation 1002. The operation 1002 illustrates heating the mixed sample solution to between approximately 80 and 100 degrees centigrade.

Heating the mixed sample solution may provide sensitivity of the mixed sample solution to analytical testing. For instance, heating the mixed sample solution may aid in conversion of reduced species to oxidized species, or may aid in solvent removal in analytical equipment. It may be appreciated that the mixed sample solution may be heated to an appropriate range sufficient to aid in conversion of reduced species to oxidized species and in removal of solvent from the analytical equipment and the sample introduction system, while avoiding analytical inaccuracies. For example, gaseous formations in lines of the sample introduction system may adversely affect analysis of the sample by an analytical system, such as in the accuracy of results. Thus, the temperature of the mixed may be maintained below a threshold value to avoid developing gaseous formations in the lines of sample introduction systems.

As explained above, the sample introduction system may include heating elements to heat at least a portion of the mixed sample solution. Alternatively, an initial sample solution may be introduced to the sample introduction system with heated solutions of reagents including, for example, sulfuric acid, hydrochloric acid, hydrogen peroxide, and/or nitric acid being added previously, subsequently, or simultaneously. Still alternatively, the initial sample solution may be pre-heated prior to introduction to the sample introduction system. Where a continuous flow system is utilized, the heating may be controlled by controlling the flow rate of the system, such as by selecting a length of loop through which the solution flows, by choosing a residence time of the system, and/or controlling when various injection valves are enabled to introduce other solutions to the sample introduction system. The length of the loop may depend on the flow rate of the system and on heating element capabilities. Additionally, the flow rate may depend on which analytical equipment is utilized. For instance, a lower flow rate may be utilized for use on an ICP-MS than the flow rate for use on an ICP-AES.

Referring now to FIG. 11, a graph 1100 of intensity over time of an initial sample solution analyzed on analytic equipment is displayed. The sample tested in FIG. 2 included approximately 100 parts per billion (ppb) of arsenic in reduced form (As³⁺), selenium in reduced form (Se⁴⁺), thallium, and lead. The graph shows results of an ICP-AES wherein a loop in the sample introduction system was heated for a period 1102, and subsequently the heating was disabled 1104, thereby allowing the loop to return to ambient or room temperature 1106. The test of FIG. 2 was run independent of a sample introduction solution, to enable independent analysis of the benefits of heating a test solution prior to introduction to analytical equipment. As shown in FIG. 11, each analyte displayed a higher intensity when the loop was heated or was subsequently cooling than when the loop was ambient or room temperature. For example, lead 1108 shows a relatively dramatic decrease in intensity over time, while each detection spectrum of thallium 1110, selenium 1112, 1118, and arsenic 1114, 1116 displayed a net decrease in intensity when the loop reached ambient or room temperature.

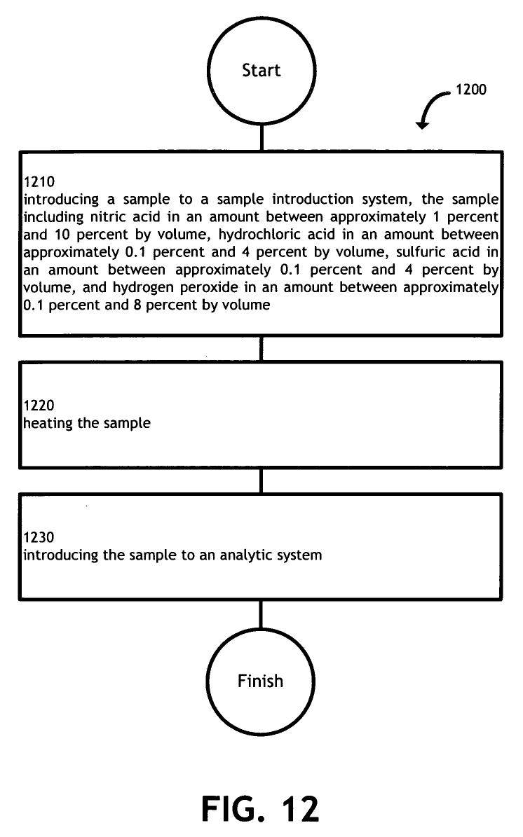

FIG. 12 illustrates an operational flow 1200 representing example operations related to introducing a sample for analysis. In FIG. 12 and in following figures that include various examples of operational flows, discussion and explanation may be provided with respect to the above-described examples of FIGS. 1 through 2A and 2B, and/or with respect to other examples and contexts. However, it should be understood that the operational flows may be executed in a number of other environments and contexts, and/or in modified versions of FIGS. 1 through 2A and 2B. Also, although the various operational flows are presented in the sequence(s) illustrated, it should be understood that the various operations may be performed in other orders than those which are illustrated, or may be performed concurrently.

After a start operation, the operational flow 1200 moves to an operation 1210. Operation 1210 depicts introducing a sample to a sample introduction system, the sample including nitric acid in an amount between approximately 1 percent and 10 percent by volume, hydrochloric acid in an amount between approximately 0.1 percent and 2 percent by volume, sulfuric acid in an amount between approximately 0.1 percent and 4 percent by volume, and hydrogen peroxide in an amount between approximately 0.1 percent and 4 percent by volume. For example, as shown in FIGS. 1 through 2A and 2B, at least a portion of the sample solution 104 and at least a portion of the sample introduction solution 102 may be combined prior to 105a introduction to the sample introduction system. Additionally, at least a portion of the sample solution 104 and at least a portion of the sample introduction solution 102 may be combined within the sample introduction system 106, such that the mixed sample solution 107 includes nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 8 percent by volume.

Then, operation 1220 depicts heating the sample. Heating the sample was discussed above. Then, operation 1230 depicts introducing the sample to an analytic system. For example, as shown in FIGS. 1 through 2A and 2B, the analytic system may be analytical equipment 108, such as an ICP-AES, an ICP-MS, or other instrument suitable for detecting at least one trait of individual elements in a sample.

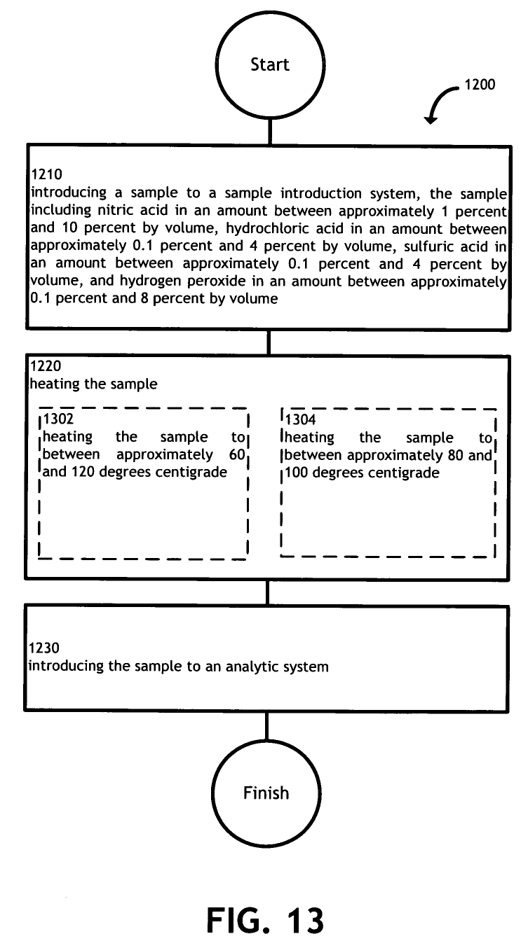

FIG. 13 illustrates alternative embodiments of the example operational flow 1200 of FIG. 12. FIG. 13 illustrates example embodiments where the operation 1220 may include at least one additional operation. Additional operations may include an operation 1302, and/or an operation 1304.

The operation 1302 illustrates heating the sample to between approximately 60 and 120 degrees centigrade. The operation 1304 illustrates heating the sample to between approximately 80 and 100 degrees centigrade.

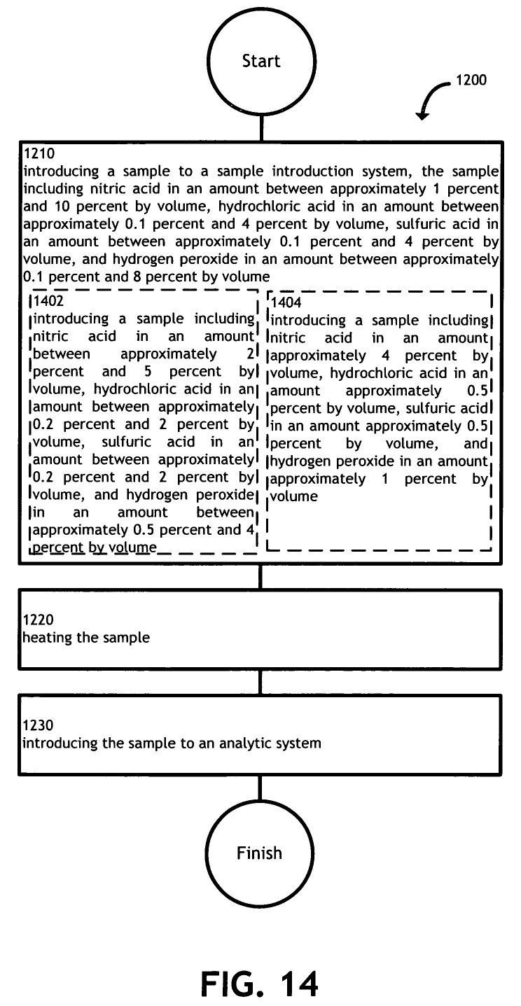

FIG. 14 illustrates alternative embodiments of the example operational flow 1200 of FIG. 12. FIG. 14 illustrates example embodiments where the operation 1210 may include at least one additional operation. Additional operations may include an operation 1402, and/or an operation 1404.

The operation 1402 illustrates introducing a sample including nitric acid in an amount between approximately 2 percent and 5 percent by volume, hydrochloric acid in an amount between approximately 0.2 percent and 2 percent by volume, sulfuric acid in an amount between approximately 0.2 percent and 2 percent by volume, and hydrogen peroxide in an amount between approximately 0.5 percent and 4 percent by volume.

The operation 1404 illustrates introducing a sample including nitric acid in an amount approximately 4 percent by volume, hydrochloric acid in an amount approximately 0.5 percent by volume, sulfuric acid in an amount approximately 0.5 percent by volume, and hydrogen peroxide in an amount approximately 1 percent by volume.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A sample introduction solution for increasing the sensitivity of a sample for detection of trace elements by analytical equipment, comprising:
nitric acid in an amount between approximately 1 percent and 10 percent by volume;
hydrochloric acid in an amount between approximately 0.1 percent and 4 percent by volume;
sulfuric acid in an amount between approximately 0.1 percent and 4 percent by volume; and
hydrogen peroxide in an amount between approximately 0.1 percent and 8 percent by volume.

2. The sample introduction solution of claim 1, wherein the amount of nitric acid is between approximately 2 percent and 5 percent by volume.

3. The sample introduction solution of claim 1, wherein the amount of hydrochloric acid is between approximately 0.2 percent and 2 percent by volume.

4. The sample introduction solution of claim 1, wherein the amount of sulfuric acid is between approximately 0.2 percent and 2 percent by volume.

5. The sample introduction solution of claim 1, wherein the amount of hydrogen peroxide is between approximately 0.5 percent and 4 percent by volume.

6. The sample introduction solution of claim 1, wherein the amount of nitric acid is approximately 4 percent by volume, the amount of hydrochloric acid is approximately 0.5 percent by volume, the amount of sulfuric acid is approximately 0.5 percent by volume, and the amount of hydrogen peroxide is approximately 1 percent by volume.

7. A method of increasing analysis sensitivity of a sample, comprising:
preparing an initial sample solution using at least one of nitric acid or hydrochloric acid;
determining whether the initial sample solution includes a sufficient amount of hydrochloric acid to obtain a hydrochloric acid concentration of between 0.1 percent and 4 percent by volume in a mixed sample solution; and
adding a sufficient amount of at least one of sulfuric acid, hydrogen peroxide, or hydrochloric acid according to the determination to provide in the mixed sample solution a sulfuric acid concentration of between approximately 0.1 percent and 4 percent by volume, a hydrogen peroxide concentration of between approximately 0.1 percent and 8 percent by volume, a hydrochloric acid concentration of between approximately 0.1 percent and 4 percent by volume, and a nitric acid concentration of between approximately 1 percent and 10 percent by volume.

8. The method of claim 7, wherein adding a sufficient amount of at least one of sulfuric acid, hydrogen peroxide, or hydrochloric acid according to the determination includes:
adding a sufficient amount of an aqueous solution of sulfuric acid and an aqueous solution of hydrogen peroxide to the initial sample solution to obtain a sulfuric acid concentration of between approximately 0.1 percent and 4 percent by volume, a hydrogen peroxide concentration of between approximately 0.1 percent and 8 percent by volume, a hydrochloric acid concentration of between approximately 0.1 percent and 4 percent by volume, and a nitric acid concentration of between approximately 1 percent and 10 percent by volume in the mixed sample solution, when the determination indicates that the initial sample solution includes a sufficient amount of hydrochloric acid to obtain a hydrochloric acid concentration of between 0.1 percent and 4 percent by volume in the mixed sample solution.

9. The method of claim 7, wherein adding a sufficient amount of at least one of sulfuric acid, hydrogen peroxide, or hydrochloric acid according to the determination includes:
adding a sufficient amount of an aqueous solution of sulfuric acid and an aqueous solution of hydrochloric acid to the initial sample solution to obtain a sulfuric acid concentration of between approximately 0.1 percent and 4 percent by volume and a hydrochloric acid concentration of between approximately 0.1 percent and 4 percent by volume, and adding a sufficient amount of hydrogen peroxide to obtain a hydrogen peroxide concentration of between approximately 0.1 percent and 8 percent by volume and a nitric acid concentration of between approximately 1 percent and 10 percent by volume in the mixed sample solution, when the determination indicates that the initial sample solution lacks a sufficient amount of hydrochloric acid to obtain a hydrochloric acid concentration of between 0.1 percent and 4 percent by volume in the mixed sample solution.

10. The method of claim 7, further including heating the mixed sample solution.

11. The method of claim 10, wherein heating the mixed sample solution includes heating the mixed sample solution to between approximately 60 and 120 degrees centigrade.

12. The method of claim 10, wherein heating the mixed sample solution includes heating the mixed sample solution to between approximately 80 and 100 degrees centigrade.

13. The method of claim 7, wherein adding a sufficient amount of at least one of sulfuric acid, hydrogen peroxide, or hydrochloric acid according to the determination includes:
adding a sufficient amount of at least one of sulfuric acid, hydrogen peroxide, or hydrochloric acid according to the determination to provide in the mixed sample solution a sulfuric acid concentration of between approximately 0.2 percent and 2 percent by volume, a hydrogen peroxide concentration of between approximately 0.5 percent and 4 percent by volume, a hydrochloric acid concentration of between approximately 0.2 percent and 2 percent by volume, and a nitric acid concentration of between approximately 2 percent and 5 percent by volume.

14. The method of claim 7, wherein adding a sufficient amount of at least one of sulfuric acid, hydrogen peroxide, or hydrochloric acid according to the determination includes:
adding a sufficient amount of at least one of sulfuric acid, hydrogen peroxide, or hydrochloric acid according to the determination to provide in the mixed sample solution a sulfuric acid concentration of approximately 0.5 percent by volume, a hydrogen peroxide concentration of approximately 1 percent by volume, a hydrochloric acid concentration of approximately 0.5 percent by volume, and a nitric acid concentration of approximately 4 percent by volume.

15. The method of claim 7, wherein adding a sufficient amount of at least one of sulfuric acid, hydrogen peroxide, or hydrochloric acid according to the determination includes adding a sufficient amount of at least one of sulfuric acid or hydrochloric acid via a first addition device, and adding a sufficient amount of hydrogen peroxide via a second addition device.

16. A method of introducing a sample for analysis, comprising: introducing a sample to a sample introduction system, the sample including nitric acid in an amount between approximately 1 percent and 10 percent by volume, hydrochloric acid in an amount between approximately 0.1 percent and 4 percent by volume, sulfuric acid in an amount between approximately 0.1 percent and 4 percent by volume, and hydrogen peroxide in an amount between approximately 0.1 percent and 8 percent by volume;
heating the sample; and
introducing the sample to an analytic system.

17. The method of claim 16, wherein heating the sample includes heating the sample to between approximately 60 and 120 degrees centigrade.

18. The method of claim 16, wherein heating the sample includes heating the sample to between approximately 80 and 100 degrees centigrade.

19. The method of claim 16, wherein introducing a sample to a sample introduction system includes introducing a sample including nitric acid in an amount between approximately 2 percent and 5 percent by volume, hydrochloric acid in an amount between approximately 0.2 percent and 2 percent by volume, sulfuric acid in an amount between approximately 0.2 percent and 2 percent by volume, and hydrogen peroxide in an amount between approximately 0.5 percent and 4 percent by volume.

20. The method of claim 16, wherein introducing a sample to a sample introduction system includes introducing a sample including nitric acid in an amount approximately 4 percent by volume, hydrochloric acid in an amount approximately 0.5 percent by volume, sulfuric acid in an amount approximately 0.5 percent by volume, and hydrogen peroxide in an amount approximately 1 percent by volume.
